(19) United States
(12) Patent Application Publication
(10) Pub. No.: US 2015/0057024 A1
(43) Pub. Date: Feb. 26, 2015

(54) Method And System For Tracking, Controlling, Monitoring And Dispatching Devices Based On Geo-Location Information Shared Through A Controlling Hierarchy

(71) Applicant: Locus Location Systems, LLC, West Melbourne, FL (US)

(72) Inventors: Charna Parkey, Melbourne, FL (US); Robert Mitchell, Melbourne, FL (US); Danny Caudill, Melbourne, FL (US); John McCarthy, Palm Bay, FL (US)

(21) Appl. No.: 14/465,540

(22) Filed: Aug. 21, 2014

Related U.S. Application Data
(60) Provisional application No. 61/868,831, filed on Aug. 22, 2013.

(51) Int. Cl. H04W 4/02

(52) U.S. Cl. CPC H04W 4/02
USPC 455/456.3

(57) ABSTRACT

Disclosed is a system for hierarchical-based tracking and information exchange. A location server administrator controls a hierarchy. The system includes a plurality of mobile devices. Each mobile device runs a tracking application and/or information exchange application. A location server that uses a processor to: push and/or pull tracking information controlled by the hierarchy; push and/or pull other forms of information exchange between devices and controlled by the hierarchy; control a dissemination of information between devices running the tracking application and/or information exchange application based on the hierarchy; and control the dissemination of information between devices running the tracking application and/or information exchange application based on location.

### CROSS-REFERENCE TO RELATED APPLICATIONS

This application claims priority to U.S. Provisional Application Serial No. 61/868,831, filed on Aug. 22, 2013, the entire disclosure of which is hereby incorporated herein by reference in its entirety.

### STATEMENT REGARDING FEDERALLY SPONSORED RESEARCH OR DEVELOPMENT

Not Applicable

### FIELD OF THE INVENTION

The present invention lies in the field of electronic device tracking. The present disclosure relates to a method and system for tracking, controlling, monitoring, and dispatching devices based on geo-location information shared through a controlling hierarchy.

### SUMMARY OF THE INVENTION

The invention provides a method and system for tracking, controlling, monitoring, and dispatching devices based on geo-location information shared through a controlling hierarchy that overcome the hereinafore-mentioned disadvantages of the heretofore-known devices and methods of this general type.

With the foregoing and other objects in view, there is provided, in accordance with the invention, a system for hierarchical-based tracking and information exchange.

In one embodiment, a location server administrator controls a hierarchy. The system includes a plurality of mobile devices. Each mobile device runs a tracking application and/or information exchange application. A location server that uses a processor to: push and/or pull tracking information controlled by the hierarchy; push and/or pull other forms of information exchange between devices and controlled by the hierarchy; control a dissemination of information between devices running the tracking application and/or information exchange application based on the hierarchy; and control the dissemination of information between devices running the tracking application and/or information exchange application based on location.

Although the invention is illustrated and described herein as embodied in a method and system for tracking, controlling, monitoring, and dispatching devices based on geo-location information shared through a controlling hierarchy, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a business enterprise organization chart indicating an exemplary embodiment of a system where parties can see or interact with other devices/users and/or share information or location information between users of mobile devices. It also indicates the parties who are authorized to monitor and notify other groups or individuals within the business enterprise as to the location of those groups or individuals;

FIG. 2 illustrates a system architecture in accordance with one embodiment;

FIG. 3 illustrates a screen associated with a “Settings” tab of a Location Server Administrator in accordance with one embodiment;

FIG. 4 illustrates screens associated with “Users” and “Groups” tabs of a Location Server Administrator in accordance with one embodiment

FIG. 5 illustrates an “Add New User” screen 505 in accordance with one embodiment;

FIG. 6 illustrates a mobile login screen for a tracking application in accordance with one embodiment;

FIG. 7 illustrates a screen associated with the “Users” tab of a Location Server Administrator in accordance with one embodiment

FIG. 8 illustrates a screen associated with the “Users” tab of a Location Server Administrator in accordance with one embodiment;

FIG. 9 illustrates a screen associated with the “Groups” tab of a Location Server Administrator in accordance with one embodiment;

FIG. 10 illustrates the “User Editor” screen and a screen associated with the “Change Viewable Groups” option in accordance with one embodiment;

FIG. 11 illustrates the “Groups” tab screen and a screen associated with the “Change user viewers” option in accordance with one embodiment;

FIG. 12 illustrates a map screen of the tracking application in accordance with one embodiment;

FIG. 13 illustrates a map screen of the tracking application showing additional functionality in accordance with one embodiment

FIG. 14 illustrates a Groups selection screen of the tracking application in accordance with one embodiment;

FIG. 15 illustrates a View submenu of the tracking application in accordance with one embodiment;

FIG. 16 illustrates a Tools submenu of the tracking application in accordance with one embodiment;

FIG. 17 illustrates additional information being shown on a map of the tracking application in accordance with one embodiment;

FIG. 18 is an illustration of a Radius tool selection in accordance with one embodiment;

FIG. 19 is an illustration of a Travel Time tool selection in accordance with one embodiment;

FIG. 20 illustrates a diplomatic organization using the system of the present invention and parties who can see location information in accordance with one embodiment; and

FIG. 21 illustrates a police organization using the system of the present invention and parties who can see location information in accordance with one embodiment.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software,” “software application,” and the like as used herein, are defined as a sequence of instructions designed for execution on a computer system. A “program,” “software,” “application,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

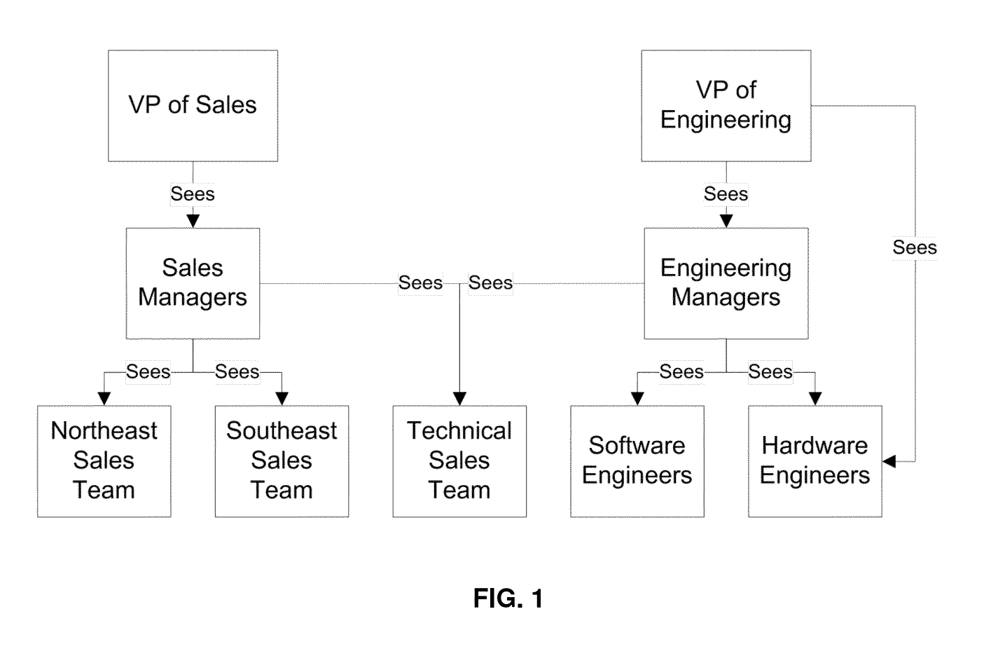

Described now are exemplary embodiments of the present invention. Referring now to the figures of the drawings in detail and first, particularly to FIG. 1, there is shown a first exemplary embodiment of a simple business enterprise organization chart and indicates the parties who can see or interact with other devices (users) and or share information or location information between users. It also indicates the parties who are authorized to monitor and notify other groups or individuals within the business enterprise as to the location of those groups or individuals.

The method and system utilizes geo-location devices to track, monitor, update, dispatch, message and govern based on hierarchical monitoring and notification. A hierarchal process (administrator) governs the parties who can see a device location and, thus, the location of the device (user) and what parties can share information with another user.

FIG. 1 presents a business enterprise organization chart of a system where parties can see or interact with other devices/users and/or share information or location information. This information could be any electronic media, picture, video, text, location between users of mobile devices. It also indicates the parties who are authorized to monitor and notify other groups or individuals within the business enterprise as to the location of those groups or individuals.

The method of the invention allows dynamic editing of the hierarchical monitoring and notification, polling and the controlling parties based on business enterprise rules, reporting relationships, and geographical rules. The system provides the ability to edit and update these restrictions imposed on the availability of the location information, business rules, or other hierarchical defined structure.

The devices and process are carrier agnostic, requiring only a data plan, and uses Internet connectivity as the delivery backbone. The process supports all smartphone operating systems (OS), such as for example, Android OS™, Palm webOS™, Symbian™, iPhone™, RIM Blackberry™, etc. and can also be employed over a WiFi or other wireless network. The system's components comprise:
1) A location sensor—a hardware device supporting any one or more of a plurality of communication and location based technologies (phones and phone apps) married with firmware or software to create a collaborative device providing location information and messages to a communication infrastructure. In one exemplary embodiment, the system uses an Extensible Messaging and Presence Protocol (XMPP) and a data communication service;
2) Mapping tool/interface—A geographically based software tool, on one or more ends of the communication network (i.e., the user's device and a central station or server), to create, edit, and display dynamic rules based on geographic information passed between the communication/locating devices and the central station or information processor. The geo-location information is plotted on a map and a system operator can create and amend rules that govern the locations displayed, polling/refresh rates, and the observing parties who can see those locations;
3) Group/user management infrastructure/interface—A method and process for controlling the interaction of hardware devices, software applications and users. This management infrastructure represents a unique component of the system and method of the present invention because it permits an administrator to govern who can see the location information, which location information each location observer can see, the parties to whom the location information can be forwarded, and the controlling parties who can control the location for each monitored individual (device);
4) Communications infrastructure—The Internet, local area networks (LAN), wide area networks (WAN), mobile phone network, land line network, etc.;
5) Network infrastructure—A private network, a secure network, or a public network;
6) Processing infrastructure—A single computing device and or a distributed network of computing devices;
7) Information processor/router—A method or process for controlling the information flow between hardware devices, software applications, and users (e.g., a location server, an xmpp server).

The Location sensor comprises a hardware device with location technology, including but not limited to:
1) Global positioning system (GPS);
2) Assisted GPS (AGPS);
3) Time Difference of Arrival (TDOA);
4) Radio propagation ranging and distance measurements;
5) Angle of Arrival (AOA);
6) Mapped public Wifi Access point;
7) Inertial navigation aids.

The mapping tool comprises a platform-independent geographic information system that displays a device location on a map at one or more locations (the central station and at the hand held device operated by the user). The tool can also display additional information derived from the transmission of the device, hardware sensor information provided on the device or attached to the device or calculated from a combination of hardware and radio signal information.

The group/user management infrastructure comprises:
1) A user console that provides administrative functionality to control user access into the system and access to tracked groups and tracked individuals, as permitted by the system administrator;
2) A process to control access to the system, for example, limiting access to a linear reporting hierarchy within an organizational structure of a business enterprise or groups within that enterprise;
3) A process allowing 3D control of groups and users, i.e., control over individual branches within the hierarchy;
4) A method allowing dynamic, unattended access control of groups or users;
5) A method for communicating and sharing information and media, based on tracking and proximity, as tied to and governed by access control parameters as established by the system administrator or authorized operator;
6) A method providing unattended dynamic proximity dispatch, tracking and communication.

The communications infrastructure comprises:
1) The provisioning of dynamic network connectivity between sensors and location processor/router;
2) A dynamically configured system of hierarchical routed communication (e.g., person to person (P2P), business to business (B2B), one to many, many to one);
3) A method to perform preliminary authentication of users, groups, systems, etc.

The Network infrastructure comprises:
1) A connection or method of connecting devices to a central information storage server for the purpose of information exchange, information control, and information dissemination;
2) The connection can be always connected or intermittent;
3) A method to dynamically configure connectivity between devices and information.

The Processing infrastructure comprises:

1) At least one device (device A) to process location information and facilitate control and structure in disseminating and distribute information to at least 1 device (device B) used to process the information;
2) At least one device (device B) to capture location information and facilitate the information exchange with and least one other device (device A);
3) At least one device (device A or device B or device C etc.) used to process the information exchange between device A and device B, device A and device C, device B and device C, for viewing shared information;
4) The device to process location information can be located at a static location, a roaming location or virtual location (cloud computing);
5) The device for capturing (the process of) location information can be located at a static location, a roaming location, a virtual location, or a synthesized location.

The Information processor/router comprises:
1) Providing dynamic routing information to authorized devices/applications based on authentication, groups, users, etc.;
2) The processor restricts access to the system;
3) The processor restricts and adjusts routes based on commands from users and or group managers, business rules, geographical locations, and location updates;
4) The processor manages and partitions account information into manageable systems, groups, user, etc.

FIG. 1 represents a business enterprise employing the system of the present invention and parties who can see location information. The connecting arrows indicate parties who are able to monitor location information and to whom the location information can be provided.

A hierarchy of groups is used to restrict which users a certain individual may monitor. An organization's most important assets, e.g., people, equipment, vehicles, are tracked using the hierarchy on which the organization depends. In the embodiment described in FIG. 1, an organizational structure depicts a company having a Vice President of Sales and a Vice President of Engineering. In this hierarchical structure, the Vice Presidents can see the location of only certain managers and the managers can see the location of only certain workers from the various teams/groups underneath them.

The present disclosure provides a system for hierarchical-based tracking and information exchange. A location server administrator controls a hierarchy. The system includes a plurality of mobile devices. Each mobile device runs a tracking application and/or information exchange application. A location server that uses a processor to: push and/or pull tracking information controlled by the hierarchy; push and/or pull other forms of information exchange between devices and controlled by the hierarchy; control a dissemination of information between devices running the tracking application and/or information exchange application based on the hierarchy; and control the dissemination of information between devices running the tracking application and/or information exchange application based on location.

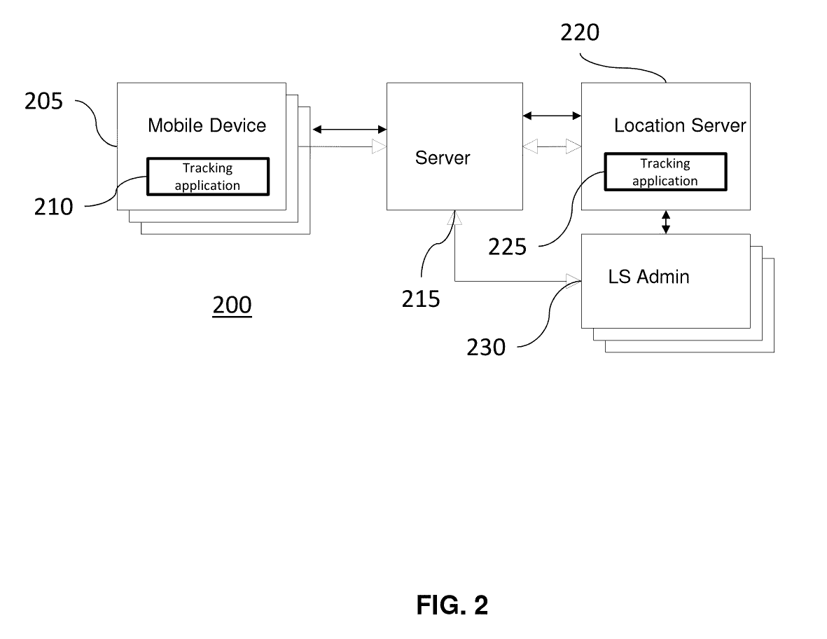

FIG. 2 illustrates a system architecture 200 in accordance with one embodiment. The architecture 200 includes one or more mobile devices 205, e.g., one or more location sensors, running a tracking application 210, e.g., mapping tool. The tracking application 210, 225 provides location updates and mapping functionality. A server 215 provides robust communication. A location server 220, e.g., an information processor/router, maintains user locations and hierarchy information. The location server 220 also includes tracking application 225, e.g., mapping tool, which pushes location updates to the one or more mobile devices 205 and receives location information from the one or more mobile devices 205. A location server administrator (LSAdmin) 230, e.g., a group/user management infrastructure/interface, provides administrative functions. In one embodiment, the server 215 and/or location server 220 are implemented using a physical server or virtual server (e.g., a cloud-based server). The mobile application 210 on the mobile devices allows the monitoring/viewing of locations of other users. The tracking application 210 of the mobile device sends location data to the location server 220 through the communication server 215. The mobile application 225 of the location server pushes location data to one or more mobile devices in accordance with the hierarchical structure through the communication server.

The location server administrator 230 handles when to turn tracking on and off. In one embodiment, each mobile device 205 running the mobile application 210 has its own timer update. The timer update is controlled by the location server, meaning the location server can change the update timer on each device remotely.

The location server 220 pushes location changes to each device in the group. The mobile device is not relied upon to pull information from the location server. The location server pushes location information and/or other information, e.g., any electronic media, picture, video, text, etc. to the one or more mobile devices 205 based on the most recent location updates from all devices within the hierarchy.

In one embodiment, the location server administrator 230 keeps track of timing for receiving location updates from the one or more mobile devices. In one embodiment, one or more devices in the hierarchy need to send location updates more often than other devices in the hierarchy.

In one embodiment, geofencing is employed for devices within the hierarchy. In this embodiment, the location server does not push location changes to each device in the hierarchy and/or group until a user within that hierarchy or group moves outside of a pre-defined area. In another embodiment, a user's mobile device does not send a location update to the location server until the user moves outside of a pre-defined area.

In one embodiment, other information can also be tracked. In one embodiment, speed and/or direction can be tracked for a user of the mobile device. This information can be gleaned from (x,y) information from the GPS chip of the mobile device. Triangulation can also be used to determine the speed of a user.

In one embodiment, a third party service provider controls the central server hardware. In this embodiment, many customers (and their corresponding hierarchical structures) share one server and location server. Each customer's data is isolated from the other customers.

In one embodiment, the customer controls the central server hardware. In this embodiment, there is one customer per server and location server.

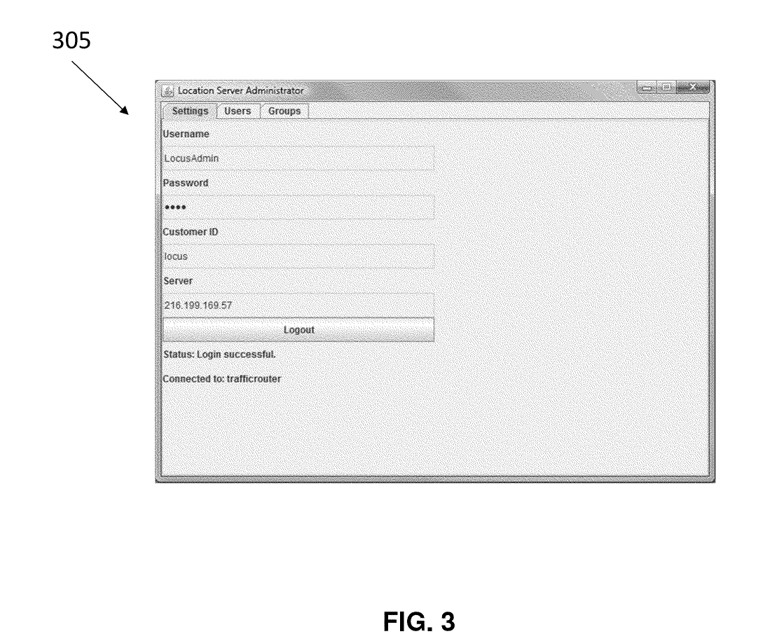

FIG. 3 illustrates a screen 305 associated with a “Settings” tab of a Location Server Administrator in accordance with one embodiment. The third party service provider creates an administrative user for a new customer and provides the Location Server Administrator. The customer uses this account along with an assigned customer identifier to login to the Location Server Administrator. In one embodiment, the customer can create more administrative user accounts.

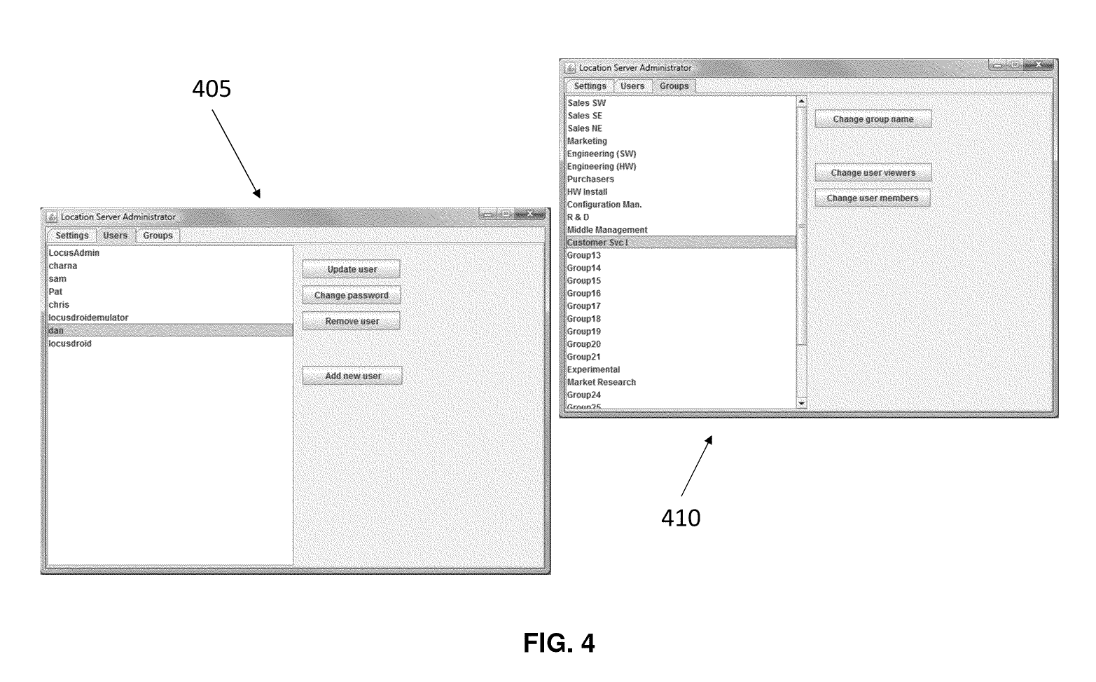

FIG. 4 illustrates screens associated with “Users” and “Groups” tabs of a Location Server Administrator in accordance with one embodiment. The screen 405 associated with the “Users” tab shows a list of all users. Options available on this screen include updating a user, changing a password of the user, removing a user, and adding a new user. The screen 410 associated with the “Groups” tab shows a list of all groups. Options available on this screen include changing the group name, changing user viewers, and changing user members.

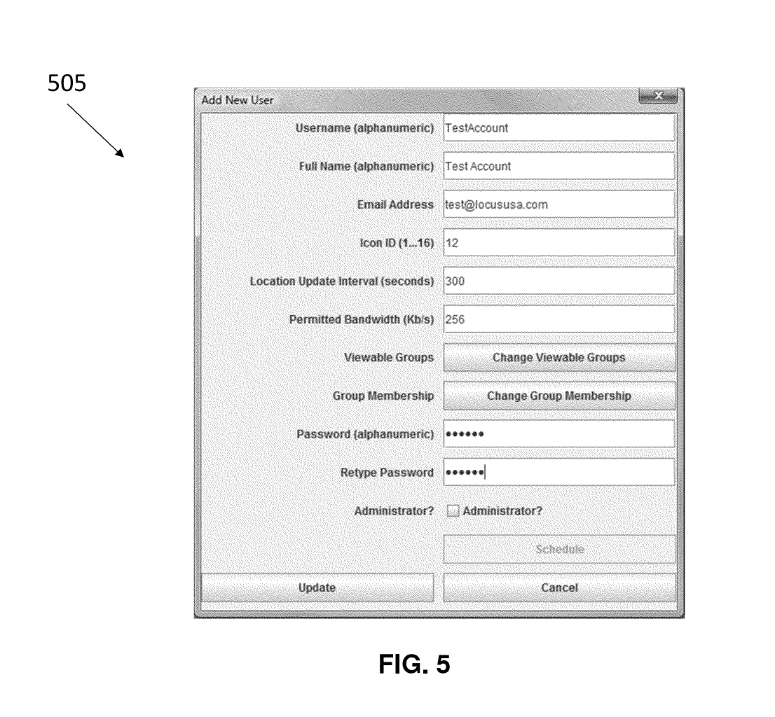

FIG. 5 illustrates an “Add New User” screen 505 in accordance with one embodiment. The customer uses the Location Server Administrator to add new users. Configurable information associated with a user includes, but is not limited to, a username, a group membership, groups that are viewable by the user, an icon, a location update interval, a permitted bandwidth, a full name, an email address, and other data.

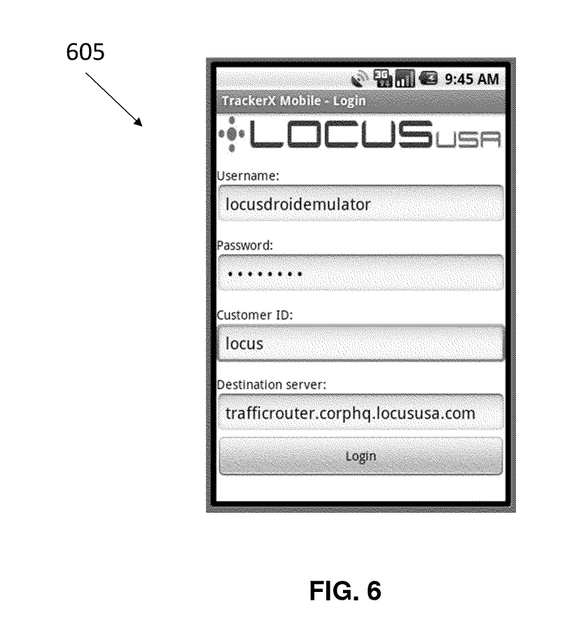

FIG. 6 illustrates a mobile login screen 605 for a tracking application in accordance with one embodiment. The user of the mobile device uses the login screen to log into the tracking application. In one embodiment, the user inputs a username, a password, a customer identifier and a destination server to log into the tracking application. Once logged into the tracking application, the user can view locations of other users in groups that the user is authorized to view. The tracking application automatically reports a current location of the mobile device. In one embodiment, the tracking application periodically updates a current location of the mobile device. The current location data provided by mobile devices using the tracking application allows the system to track users and devices. The present tracking application is not limited to one particular hardware device and/or one particular mobile operating system. Any user may log into any device to use the tracking application.

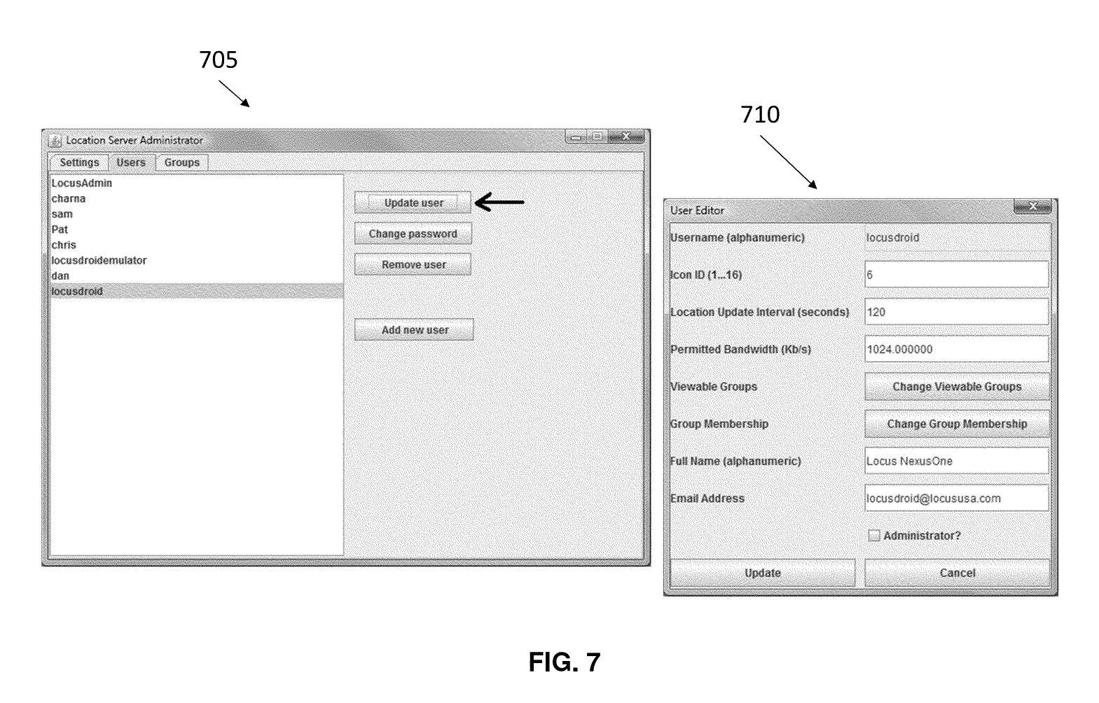

FIG. 7 illustrates a screen 705 associated with the “Users” tab of a Location Server Administrator in accordance with one embodiment. In this embodiment, for a particular user, e.g., locusdroid, the administrator may update user information using the Location Server Administrator. In this embodiment, an “Update user” option is selected, which brings up a “User Editor” screen 710. The User Editor screen 710 allows the administrator to configure various options for the user including, but not limited to, an icon, a location update interval, a permitted bandwidth, viewable groups, group membership, full name, and email address. The user can also be designated as an administrator from the User Editor screen.

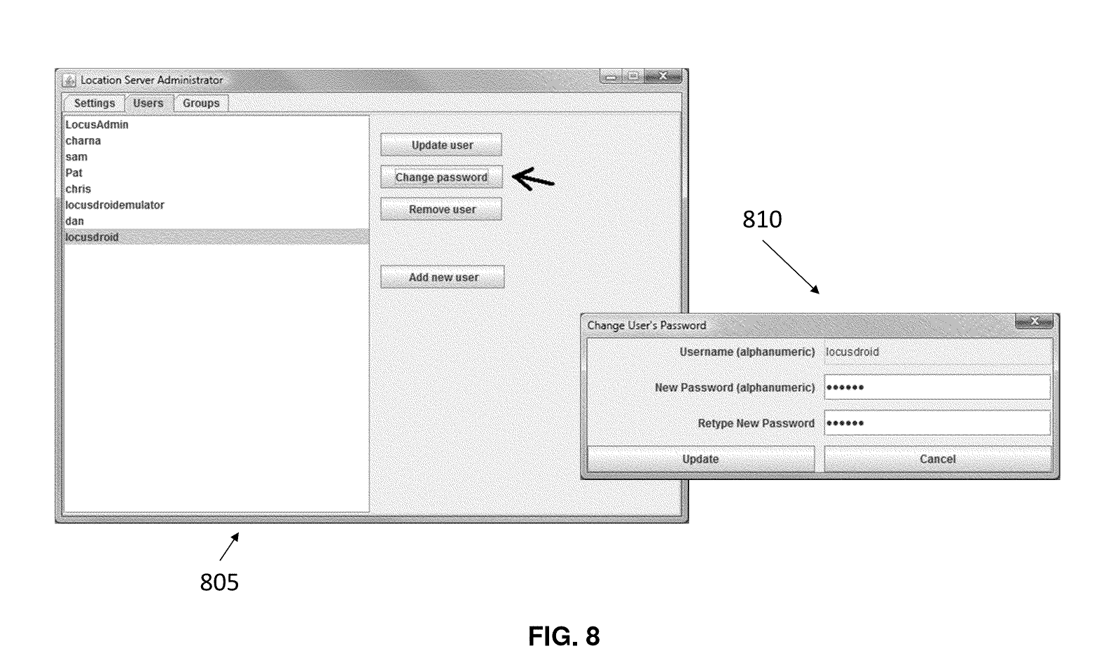

FIG. 8 illustrates a screen 805 associated with the “Users” tab of a Location Server Administrator in accordance with one embodiment. In this embodiment, for a particular user, e.g., locusdroid, the administrator may update password information for a user. In this embodiment, a “Change password” option is selected, which brings up a “Change User's Password” screen 810. In one embodiment, the new password is entered in a first field and retyped in a second field of the Change User's Password screen.

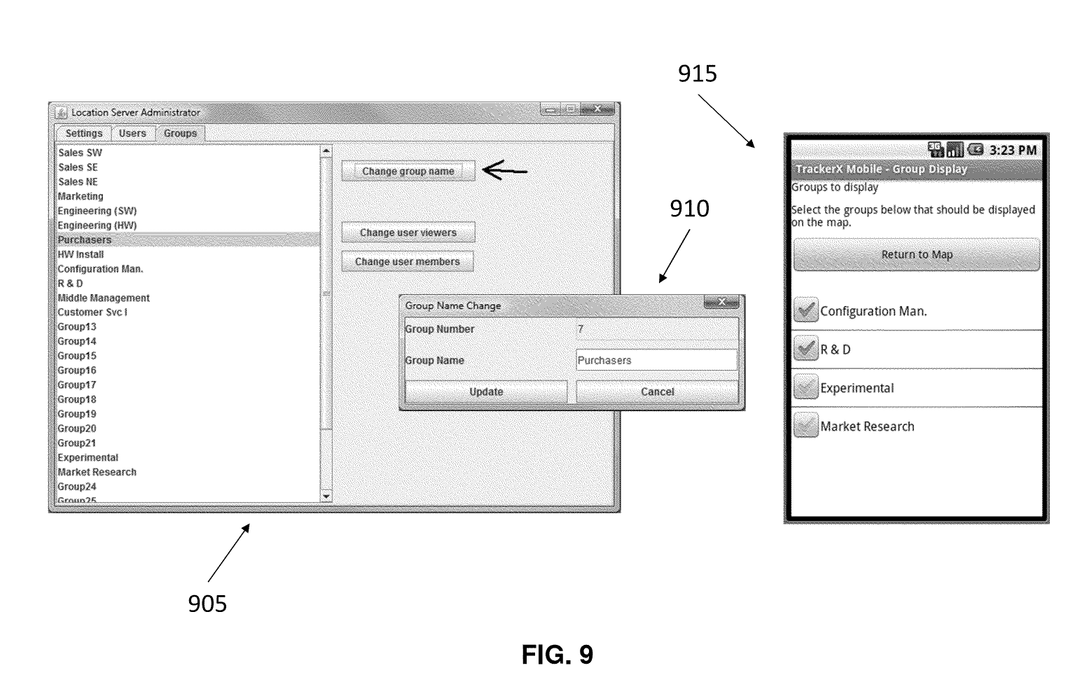

FIG. 9 illustrates a screen 905 associated with the “Groups” tab of a Location Server Administrator in accordance with one embodiment. In this embodiment, for a particular user, e.g., Purchasers, the administrator may change a group name. In this embodiment, a “Change group name” option is selected, which brings up a “Group Name Change” screen 910. On this screen, the new group name is entered in the Group Name field. Group names eligible for viewing by the user of the mobile device are shown on a Group Display screen 915 of the tracking application on the user's mobile device. Particular groups can be selected by the user for display on a map on a screen of the mobile device.

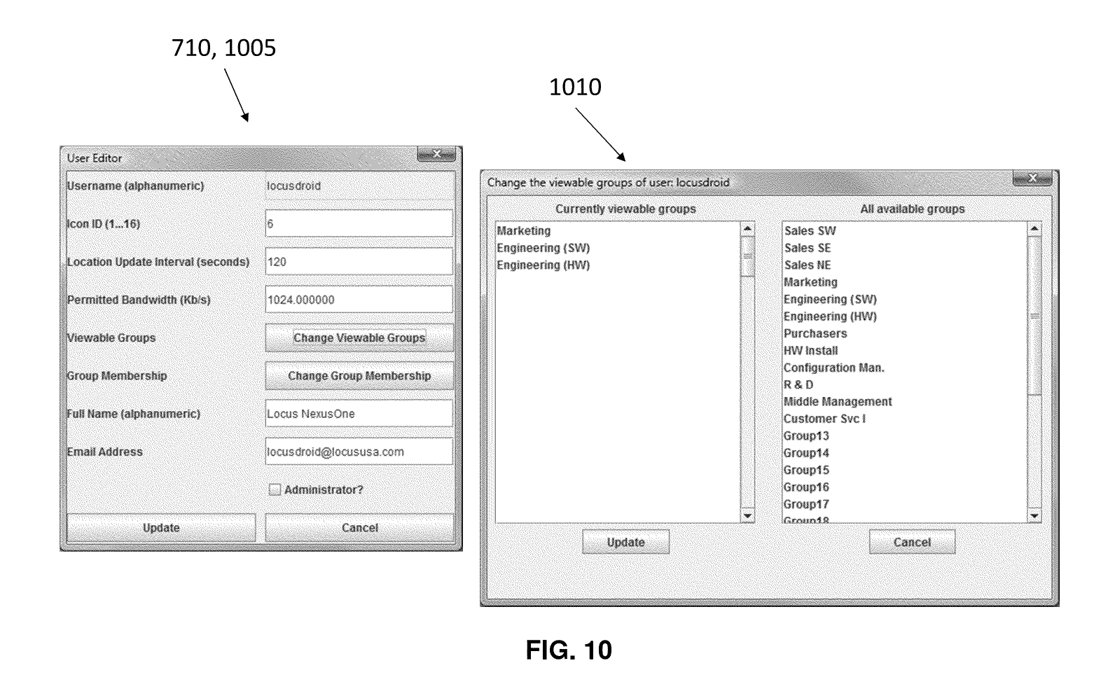

FIG. 10 illustrates the “User Editor” screen 710, 1005 and a screen 1010 associated with the “Change Viewable Groups” option in accordance with one embodiment. Groups can be managed from the User tab and User Editor screen of the Location Server Administrator. From the User Editor, the administrator selects the Change Viewable Groups option. In this particular example, the user is locusdroid. In the “Change the viewable groups of user: locusdroid” screen, currently viewable groups and all available groups are shown. Groups can be added to or removed from the currently viewable section. Once selections are made, the viewable groups are updated using the “Update” selection. If no changes are desired, the cancel option can be selected.

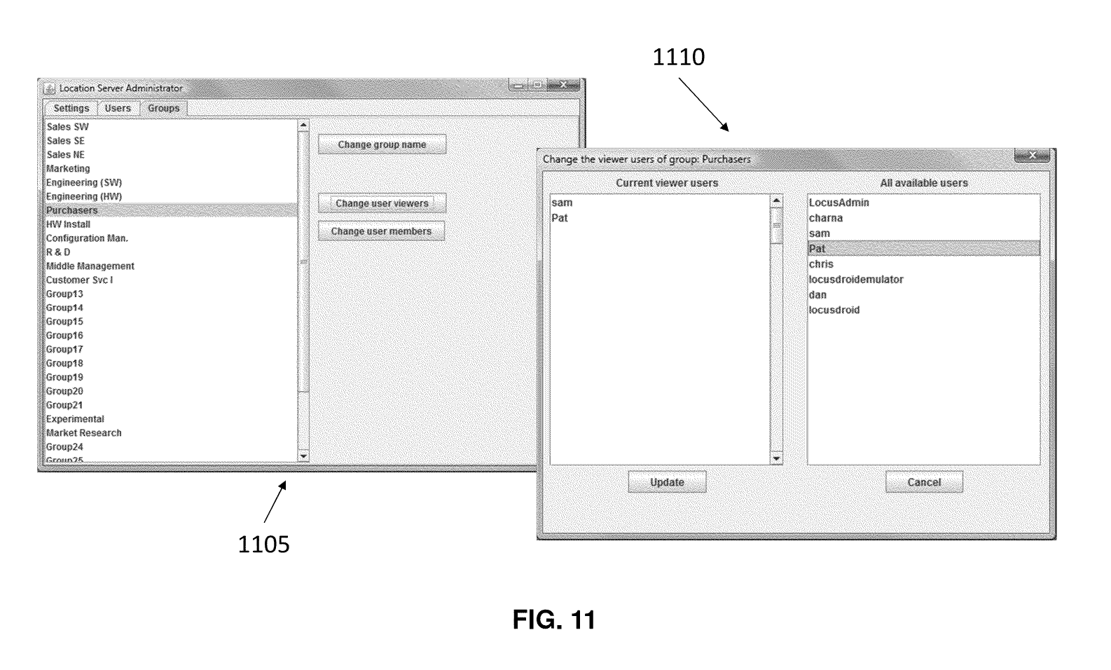

FIG. 11 illustrates the “Groups” tab screen 905, 1105 and a screen 1110 associated with the “Change user viewers” option in accordance with one embodiment. Group viewing options can be managed from the User tab of the Location Server Administrator. From the Groups tab, the administrator selects the Change user viewers option. In this particular example, the group is Purchasers. In the “Change the viewer users of group: Purchasers” screen, currently viewer users and all available users are shown. Users can be added to or removed from the current viewer users section. Once selections are made, the viewable groups are updated using the “Update” selection. If no changes are desired, the cancel option can be selected.

Returning to FIG. 6, the login screen of the tracking application can remember settings from the last successful login. In one embodiment, there is a ten second connection timeout. After a successful login, a map will appear. The map shows the locations of users that are members of groups that the present user is allowed to view. In one embodiment, the user can change their password from the mobile device.

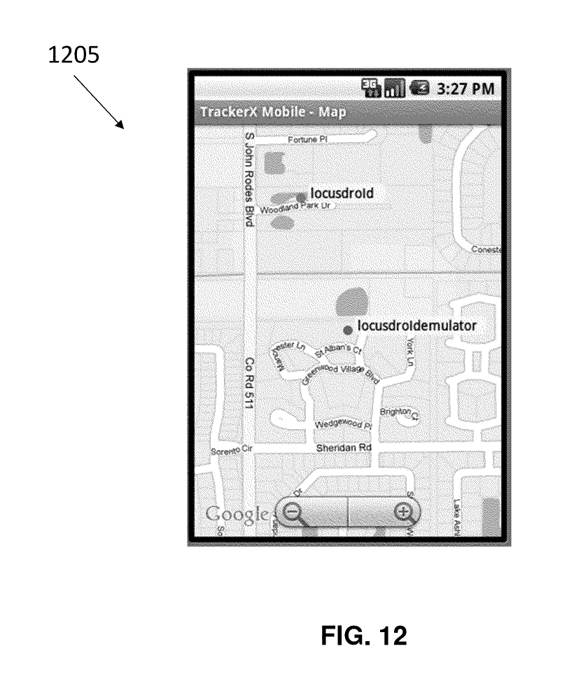

FIG. 12 illustrates a map screen 1205 of the tracking application in accordance with one embodiment. The main map screen shows the location of other users. The map screen also shows the location of the user of the mobile device. The most recent locations of users the present user is allowed to view are shown. In one embodiment, these most recent locations are shown indefinitely. In one embodiment, the menu provides additional functionality.

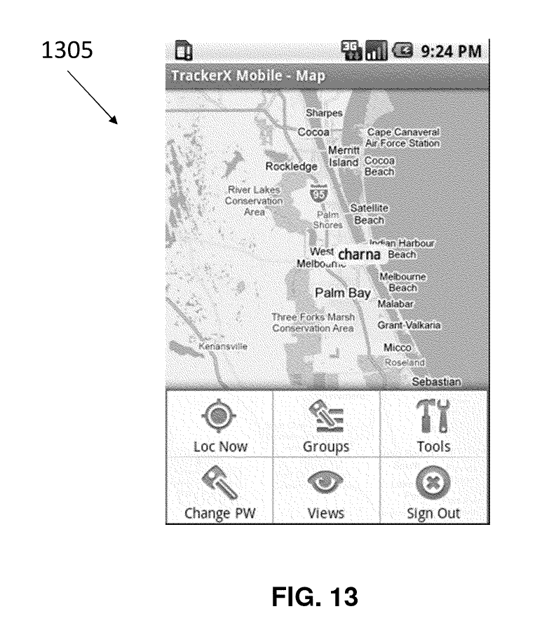

FIG. 13 illustrates a map screen 1305 of the tracking application showing additional functionality in accordance with one embodiment. The “Sign Out” option returns the tracking application to the login screen. In one embodiment, location updates will still be sent from the mobile device to the location server even when the user signs out of the tracking application. The “Groups” option allows the user to limit the display of groups on the map. The “Loc Now” option forces a location update on the phone, which updates the location server, which updates all users in the group. The “Tools” and “View” options provide additional menus.

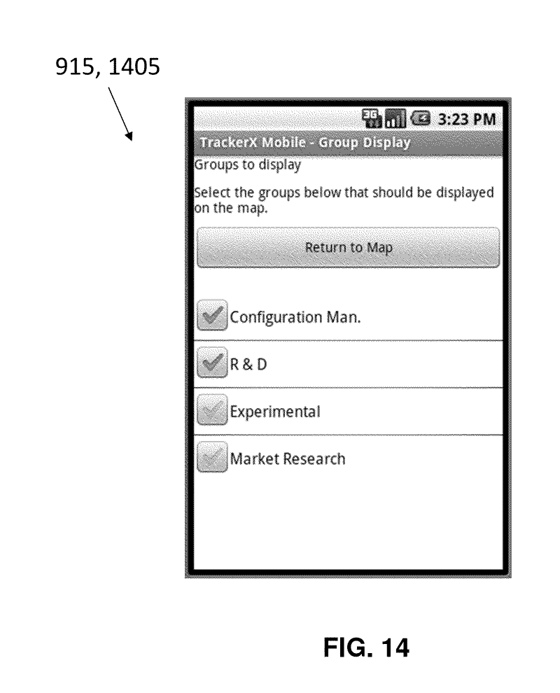

FIG. 14 illustrates a Groups selection screen 915, 1405 of the tracking application in accordance with one embodiment. The Groups selection screen shows all authorized groups, e.g., Configuration Man., R & D, Experimental, and Market Research. Any combination of authorized groups can be selected for display on the map screen of the tracking application. In one embodiment, only entire groups may be checked or unchecked, not individual users.

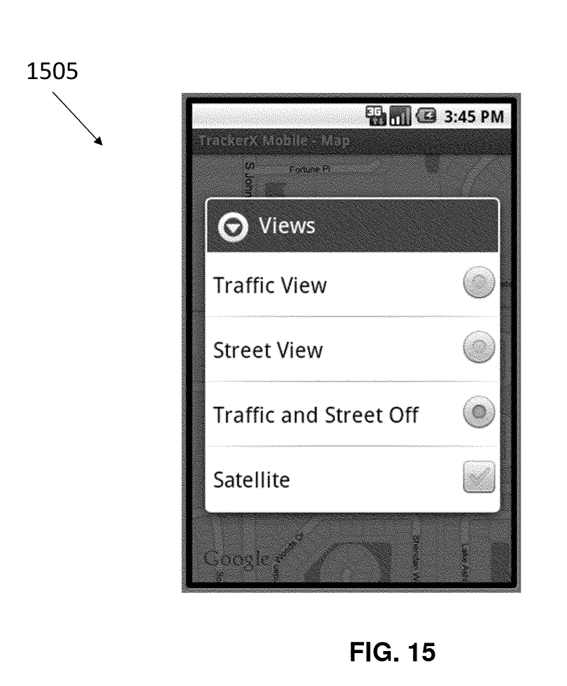

FIG. 15 illustrates a View submenu 1505 of the tracking application in accordance with one embodiment. The Traffic View provides red/yellow/green traffic guides. The Street View highlights streets (as opposed to private driveways). The Satellite View shows aerial photographs. There is also an option to turn off the Traffic View and the Street View.

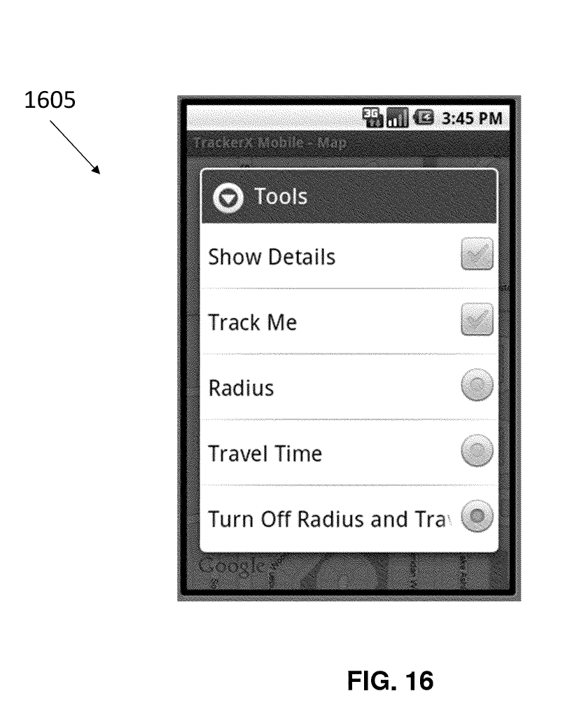

FIG. 16 illustrates a Tools submenu 1605 of the tracking application in accordance with one embodiment. The Show Details option enhances user descriptions. The Track Me option keeps the map centered on the user's location. The Radius option allows distances to be measured. The Travel Time option approximates a user's travel time based on a current speed.

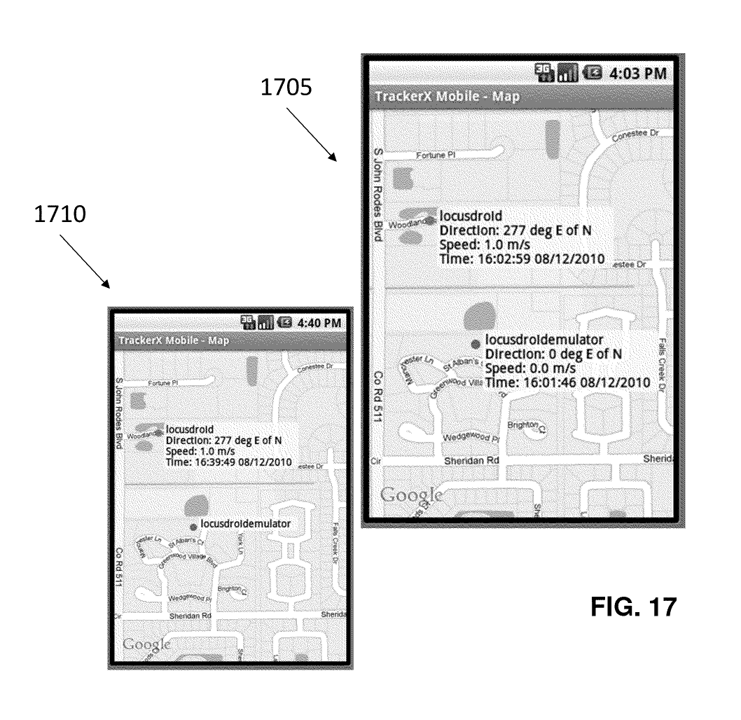

FIG. 17 illustrates additional information being shown on a map of the tracking application in accordance with one embodiment. Checking the Show Details option, e.g., from FIG. 16, reveals additional information about every icon on the map screen 1705. Double tapping an individual icon shows details for the selected individual icon on the map screen 1710.

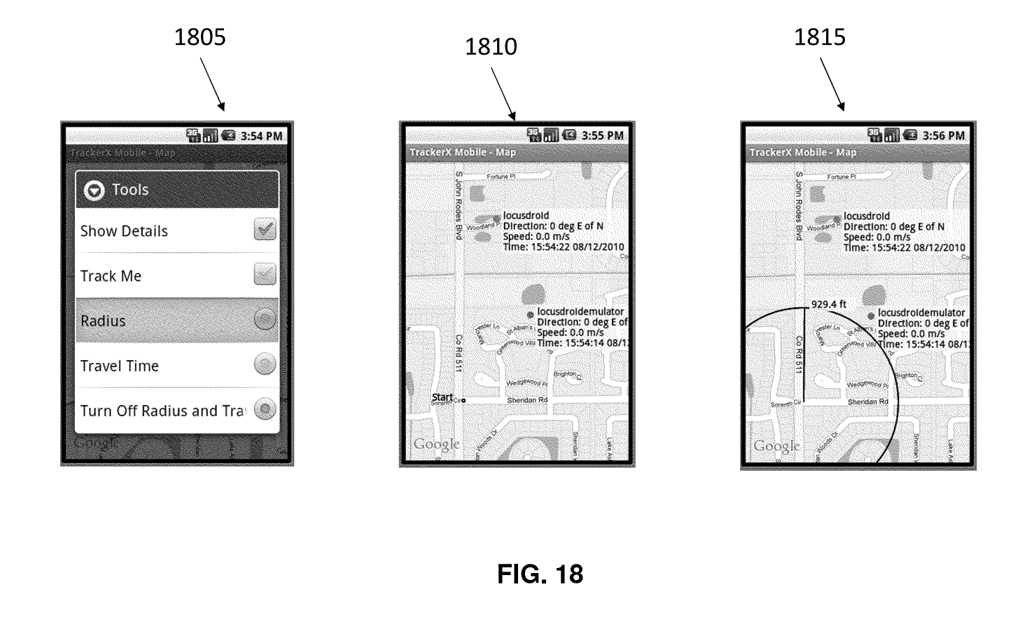

FIG. 18 is an illustration of a Radius tool selection in accordance with one embodiment. The Radius tool shows the distance between two points on the map. The user selects the Radius option to find the distance between two points from the tools submenu 1805. The user taps the screen, e.g., as shown in screen 1810, to start the Radius tool. The user taps the screen again, e.g., as shown in screen 1815, to end the Radius calculation.

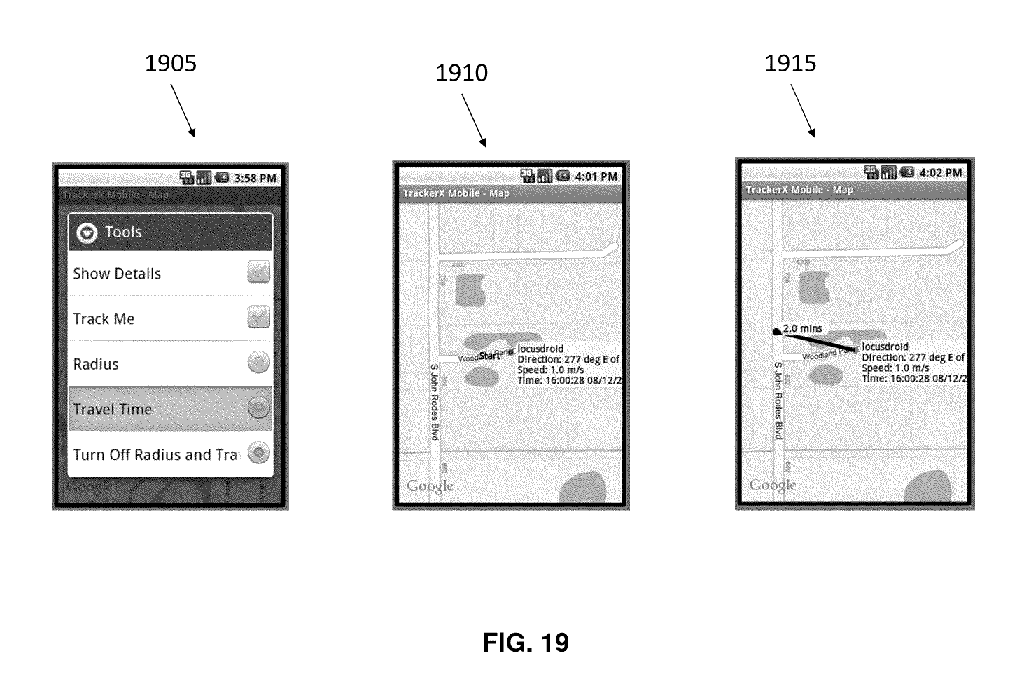

FIG. 19 is an illustration of a Travel Time tool selection in accordance with one embodiment. The Travel Time tool shows the travel time for a user to reach a location. The user selects the Travel Time option from the tools submenu 1905 to calculate travel time. The user taps the screen, e.g., as shown in screen 1910, to select a user on the map. The user taps the screen again, e.g., as shown in screen 1915, to end the Travel Time calculation.

In one embodiment, if a connection is lost for more than six seconds, the user is returned to the login screen. In one embodiment, after a user login, location updates are sent for that user until a different user logs-in (even after the phone is restarted). In one embodiment, location updates are sent at prescribed intervals in the background (even when the tracking application appears to be closed).

In one embodiment, both portrait and landscape orientations are supported on the map and group selection screens. In one embodiment, shortcut keys are provided for menu items on phones with a tactile keyboard. In one embodiment, icon backgrounds change for stale locations.

The tracking application is capable of running on mobile devices running various mobile operating systems. The Location Server Administrator and Location Server are also capable of working on various operating systems. In one embodiment, all communication between the Location Server, the Location Server Administrator, and the tracking application goes through a commercial of the shelf (COTS) server application. In this embodiment, the links are encrypted with secure socket layer (SSL). Other encryption methods are also available. In one embodiment, the Location Server must also be able to access the Server via a predefined port.

The present location tracking system provides a hierarchy of visualization of personnel. Location information can be provided, with respect to a hierarchical organization, horizontally, vertically, and/or in parallel. In one embodiment, the hierarchical structure, in addition to providing location information, can be used to send messages in groups.

The present system can be applied to an enterprise, government organizations, police forces, embassies, the military, and prisons. The present system can also be applied in a transportation and/or logistics setting, e.g., school buses, commercial transportation, trucking, rail, air transport. The present system can be applied in many contexts and should not be limited only to the aforementioned applications.

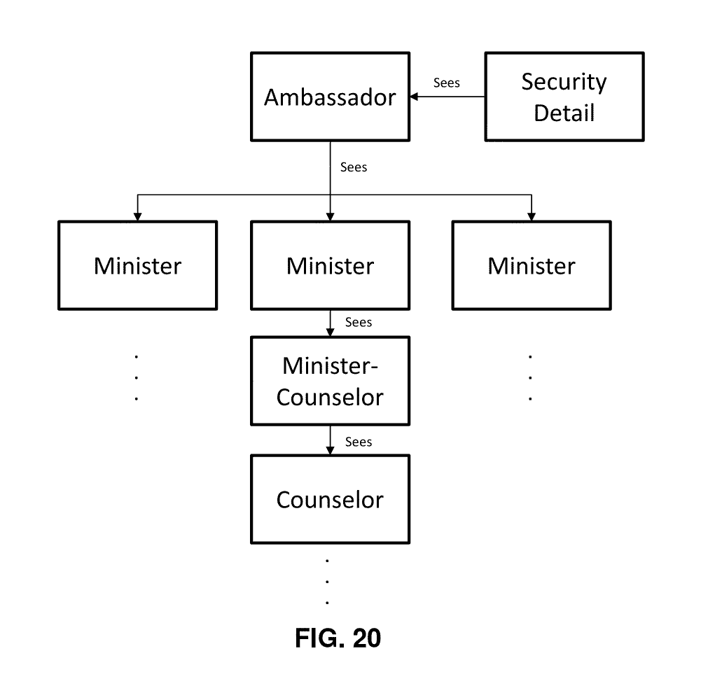

FIG. 20 illustrates a diplomatic organization using the system of the present invention and parties who can see location information in accordance with one embodiment. In one embodiment, the present system is applied in an embassy setting. In this embodiment, an ambassador and the embassy's staff make up a hierarchical organization with the ambassador being at the top, e.g., having permission to view location information for vertically under the ambassador. In addition, certain members of the embassy staff, for example, the ambassador and/or one of the other staff members, may require a security detail. In this embodiment, the ambassador has a security detail that is given access to the ambassador's location information using the present system.

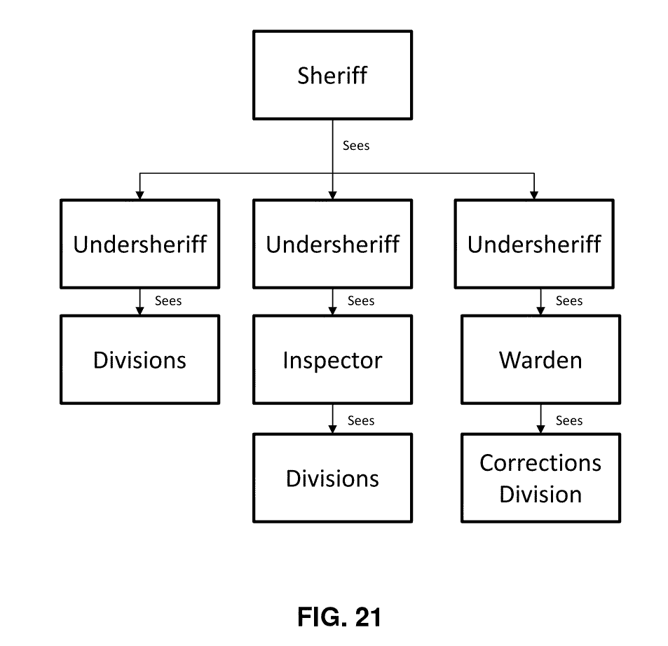

FIG. 21 illustrates a police organization using the system of the present invention and parties who can see location information in accordance with one embodiment. In this embodiment, the present system is applied in a police force setting, e.g., a sheriff's office. In this embodiment, a sheriff and officers under the sheriff make up a hierarchical organization with the sheriff being at the top, e.g., having permission to view location information for vertically under the sheriff. The sheriff may a plurality of undersheriffs having certain responsibilities, e.g., division officers, inspectors, wardens, etc.

In one embodiment, more detailed location data can be provided. For example, location data for users within a building structure can be provided. The location information can provide specific information regarding a user's location within a building, e.g., the floor a user is on and/or the room where the user is located.

Different embodiments of the invention may be implemented using different combinations of software, firmware, and/or hardware. Thus, the techniques shown in the figures, e.g., FIGS. 1 to 21, can be implemented using code and data stored and executed on one or more electronic devices (e.g., a central station, a central server, a communication server, a location server, a location server administrator, a network element, a mobile device). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for hierarchical-based tracking and information exchange, comprising:
a location server administrator that controls a hierarchy;
a plurality of mobile devices, each mobile device running a tracking application and/or information exchange application;
a location server that uses a processor to:
push and/or pull tracking information controlled by the hierarchy;
push and/or pull other forms of information exchange between devices and controlled by the hierarchy;
control a dissemination of information between devices running the tracking application and/or information exchange application based on the hierarchy; and
control the dissemination of information between devices running the tracking application and/or information exchange application based on location.
